(19) United States
(12) Patent Application Publication
(10) Pub. No.: US 2009/0230648 A1
(43) Pub. Date: Sep. 17, 2009

(54) FOLDABLE SCOOTER

(76) Inventor: Choi Wan Chan, Hong Kong (HK)

Correspondence Address: OR, NG & CHAN, 15TH FLOOR, THE BANK OF EAST ASIA BUILDING, 10 DES VOEUX ROAD CENTRAL, HONG KONG, HK

(21) Appl. No.: 12/046,476

(22) Filed: Mar. 12, 2008

(51) Int. Cl. B62M 1/00

(52) U.S. Cl. 280/87.041

(57) ABSTRACT

A foldable scooter includes a footboard, a steering column and a connecting member in between. The connecting member includes an elongated housing with an upper covering surface and two mounting seats at the rear portion, a pushing member pivotally disposed between said mounting seats, a lever pivotally connected to the rear portion of the housing for moving the pushing member. The lever is shielded substantially by the housing under the upper covering surface. The connecting member further includes a positioning member connected to a biasing device disposed at the front end of the footboard for biasing the positioning member against the mounting seats.

### FIELD OF THE INVENTION

The present invention relates to a foldable scooter.

### BACKGROUND OF THE INVENTION

There are numerous foldable scooter, for example, the U.S. Pat. Nos. 6,270,095B1 and 6,234,501B1. The main disadvantage of these two cited arts is that the folding mechanism is located on the footboard and is exposed to the outside, which can be easily activated by the user when riding the scooter by accident. The location of the mounting seats on the footboard also cause inconvenience to the user when riding the scooter. The mounting seats being exposed will easily injure the user when accident occurs.

The mounting seats in U.S. Pat. No. 7,156,405B1 are covered by a connector plate, but the slots on the plate is a dangerous feature as the user may inadvertently place the finger in the slot when folding the scooter, and be injured by the flanges moving in the slots.

There is another foldable scooter existing in the market as shown in FIGS. 1a and 1b. The disadvantage of this foldable scooter is that such folding assembly contains many open slots 910, 920, 930 for the corresponding parts to slide therein or to provide space for the folding, which cause potential hazards to the user when folding the scooter. The user may accidentally place the finger in one of the slots 910, 920, 930 and be injured when the scooter is being folded.

The lever 940 being located on the upper surface of the footboard also cause inconvenience to the user when riding the scooter. When riding the scooter, the user may accidentally kick the lever and cause the scooter to collapse to the folded condition. The footboard should be kept free from any mechanical parts.

### SUMMARY OF THE INVENTION

It is an objective of the present invention to provide an improved foldable scooter which is more safe and convenient to the user.

The scooter of the present invention includes a footboard, a steering column and a connecting member in between. The connecting member includes an elongated housing with an upper covering surface and two mounting seats at the rear portion, a pushing member pivotally disposed between said mounting seats, a lever pivotally connected to the rear portion of the housing for moving the pushing member. The lever is shielded substantially by the housing under the upper covering surface. The connecting member further includes a positioning member connected to a biasing device disposed at the front end of the footboard for biasing the positioning member against the mounting seats.

An advantage of the present invention is that the lever of the scooter of the present invention is disposed substantially inside the housing of the connecting member and is shielded by the housing. The pulling handle for pulling the lever is located on the connecting member and is distant from the footboard.

Another advantage is that the pushing member is designed not to have any sharp edges exposed to the outside. The pushing member includes a first lump and a second lump for respectively disengaging the positioning member from the mounting seats when opening and folding the scooter. The pushing member has a smooth, wide and curved surface without any sharp edges exposed to the outside to eliminate any potential injury to be caused to the user when accident occurs. The pushing member is disposed between the mounting seats with an outer exposed surface at the same level of or at a slightly higher level than the adjacent mounting seats to prevent the mounting seats from sticking out which causes potential danger to the user.

In the present invention, the main parts involved in the folding mechanism including the lever, the positioning member and the biasing device are all substantially shielded from the outside.

The present invention eliminates most of the slots and open spaces from exposing to the outside, which may cause injury to the user during the opening and folding of the scooter.

### BRIEF DESCRIPTION OF THE DRAWINGS

The above and other aspects, features, and advantages of the present invention will become more apparent upon consideration of the following detailed description of preferred embodiments, taken in conjunction with the accompanying figures, wherein:

FIG. 1a is a perspective view of a foldable scooter currently available in the market.

FIG. 1b is a partial perspective view of the foldable scooter in FIG. 1a.

FIG. 2 is a perspective view of an embodiment of this invention.

FIG. 3 is another perspective view of the foldable scooter in FIG. 2.

FIG. 4 is a side view of the foldable scooter in FIG. 2 in the open condition.

FIG. 5 is a side view of the foldable scooter in FIG. 2 in the folded condition.

FIG. 6 is an explosive view of the foldable scooter in FIG. 2.

FIG. 7 is a side view of the mounting seat of the foldable scooter in FIG. 2.

FIG. 8 is a side view of the pushing member of the foldable scooter in FIG. 2.

FIG. 9 is a side view of the lever of the foldable scooter in FIG. 2.

FIG. 10 illustrates the assembly of the connecting member, the pushing member and the mounting seat of the foldable scooter in FIG. 2.

FIGS. 11a-e illustrate the corresponding positions of the pushing member, the lever and the positioning member with respect to the mounting seat of the foldable scooter in FIG. 2 between the open and folded conditions.

FIG. 12 is a perspective bottom view of the positioning member in the footboard of FIG. 2.

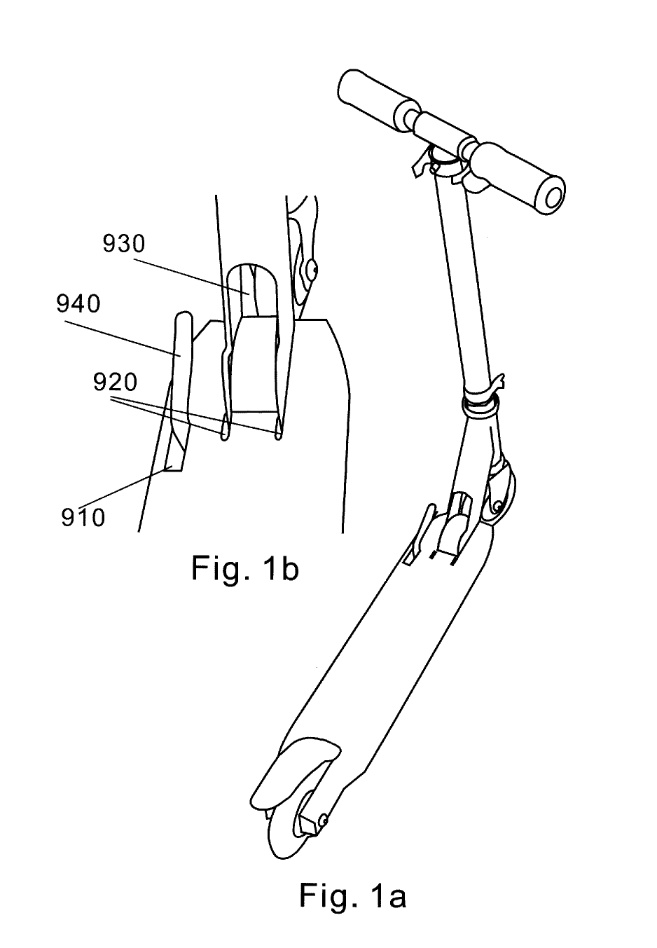

### DESCRIPTION OF A PREFERRED EMBODIMENT OF THE INVENTION

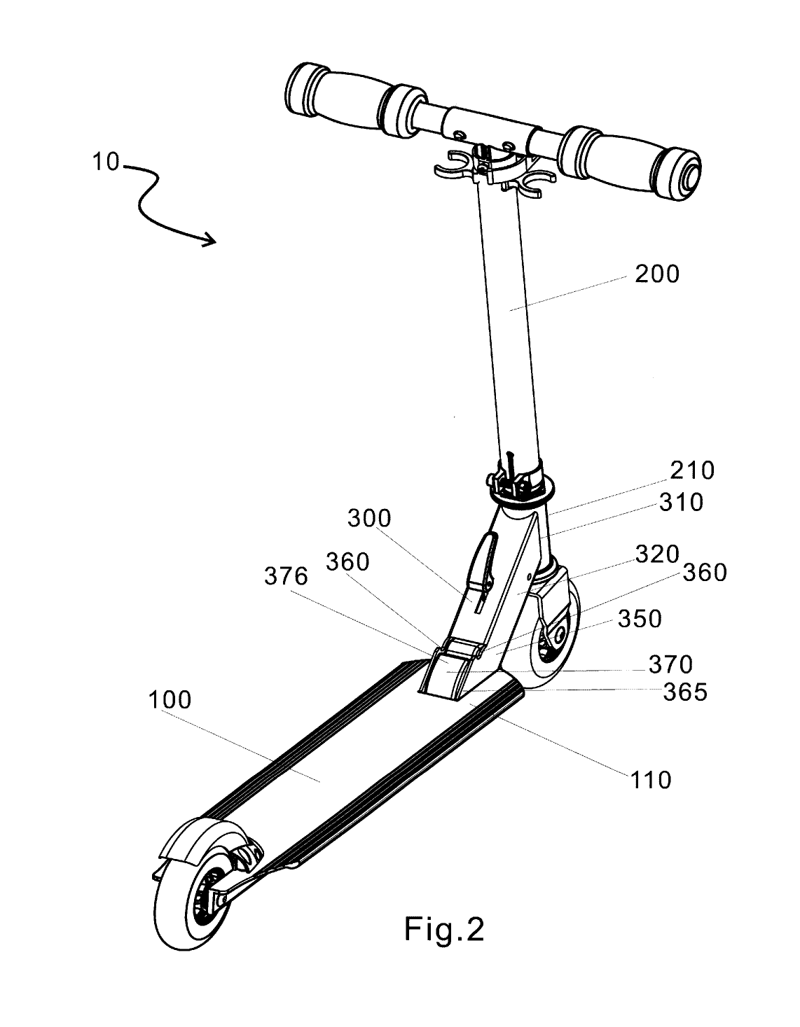

As shown in FIGS. 2-5, a preferred embodiment of the present invention is a scooter 10 including a footboard 100, a steering column 200 and a connecting member 300 connecting the footboard 100 to the steering column 200.

The connecting member 300 has a front portion 310 rotatably connected to the steering column 200, a rear portion 350 pivotally connected to a front end 110 of the footboard 100 and an elongated housing 320 in between the front portion 310 and the rear portion 350. The front portion 310, for example, is a cylindrical hollow column surrounding a lower portion 210 of the steering column 200 such that the steering column 200 can be turned freely inside the front portion 310.

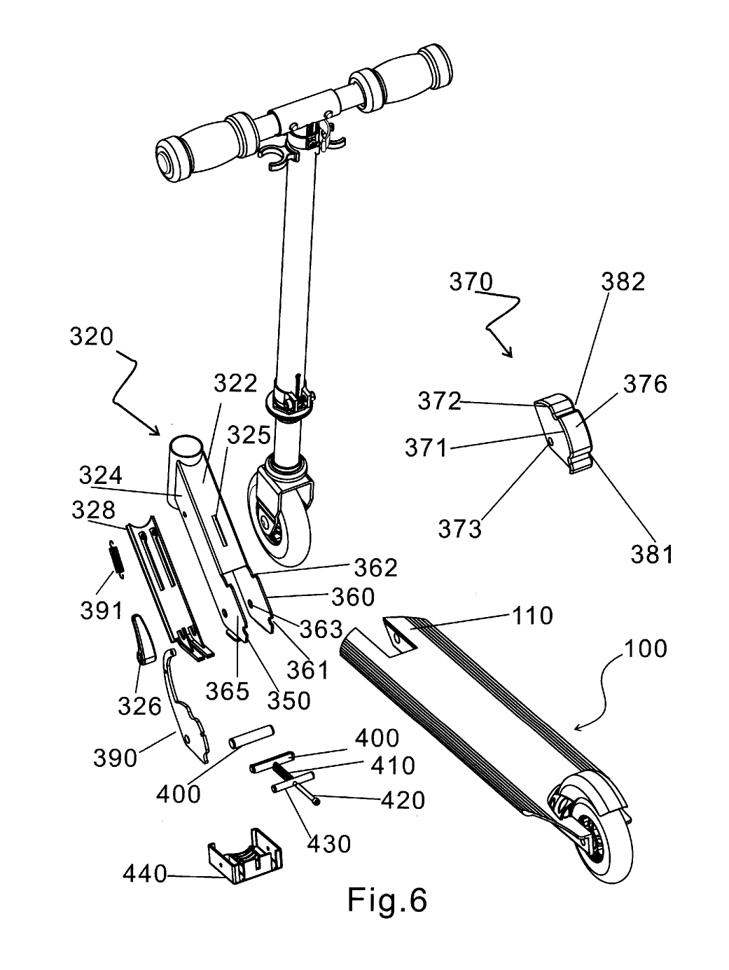

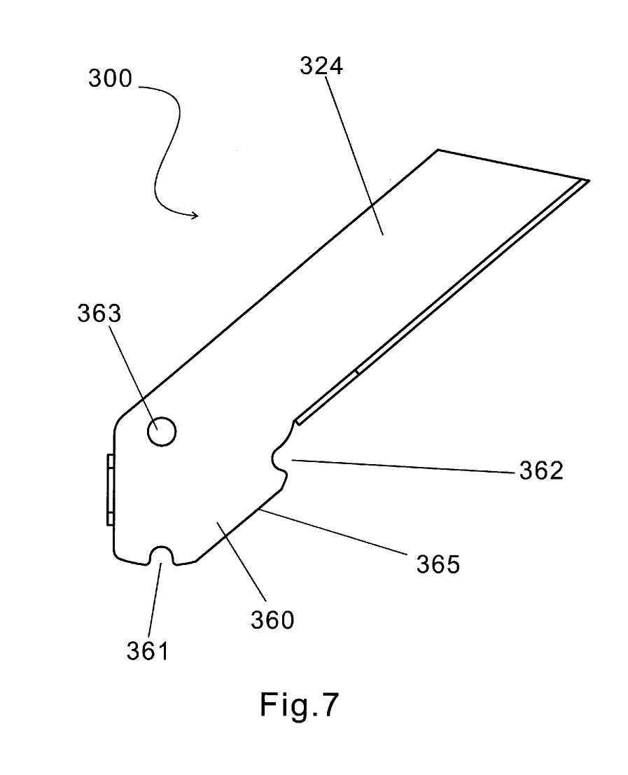

As shown in FIGS. 6 and 7, the housing 320 has an upper covering surface 322 and two walls 324 on the side. The rear portion 350 includes two mounting seats 360 extended from the side walls 324. Each mounting seat 360 contains a first pivot hole 363 for pivotally connecting to the front end 110 of the footboard 100, and a first notch 361 and a second notch 362 for receiving and engaging with a positioning member 400 respectively in the open condition and the folded condition of the scooter 10. The positioning member 400, for example, may be a positioning shaft.

The positioning member 400 is connected to a first biasing device, for example, a spring 410 disposed at the front end 110 of the footboard 100. The spring 410 biases the positioning member 400 against the mounting seats 360 to lock the positioning member 400 in the first notch 361 and the second notch 362.

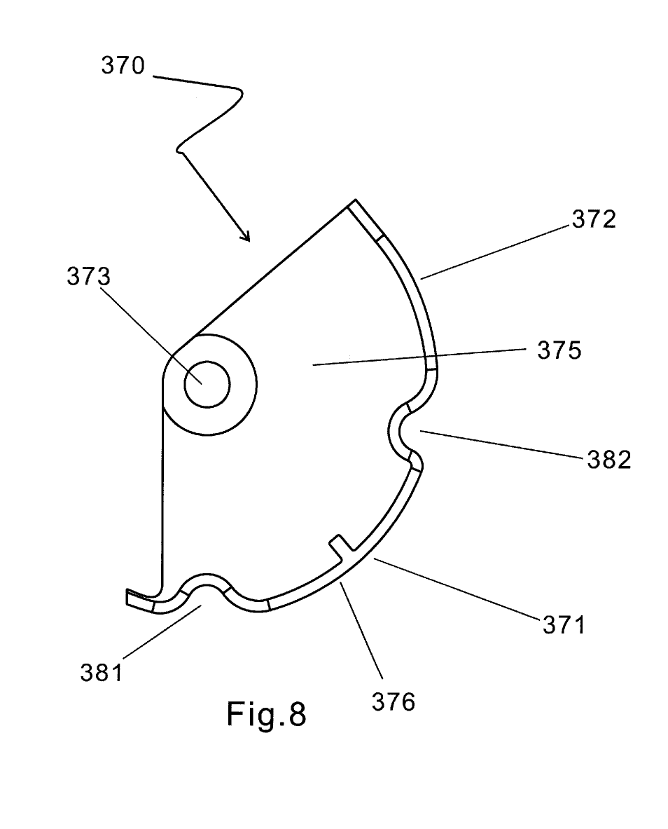

As shown in FIGS. 2, 6, 8 and 10, a pushing member 370 is disposed in the housing 320 at the rear portion 350 between the mounting seats 360 for disengaging the positioning member 400 from the mounting seats 360. The pushing member 370 has a smooth and curved outer surface 376 with a first lump 371 and a second lump 372 for pushing the positioning member 400 away from the mounting seats 360, and a first groove 381 and a second groove 382 for engaging with the positioning member 400. The first groove 381 and the second groove 382 are positioned and configured to match with the shape of the mounting seats 360 and the positions of the first notch 361 and the second notch 362. A second pivot hole 373 on the pushing member 370 is pivotally connected to the front end 110 of the footboard 100.

In the open condition, the outer surface 376 of the pushing member 370 positioned between the upper exposed portions 365 of the mounting seats 360 is at the same level of or at slightly higher level than the upper exposed portions 365, such that the exposed portions 365 do not stick out to cause danger to the user.

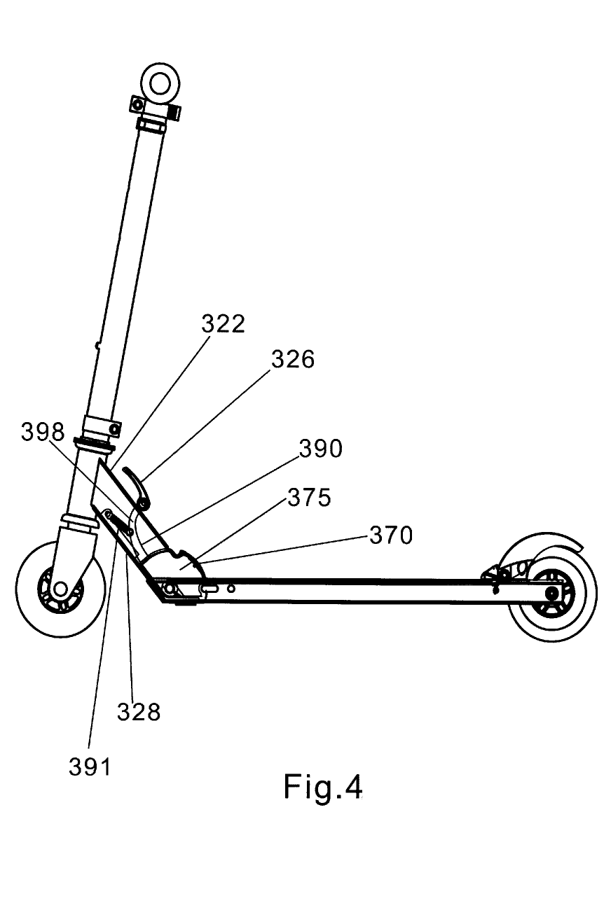

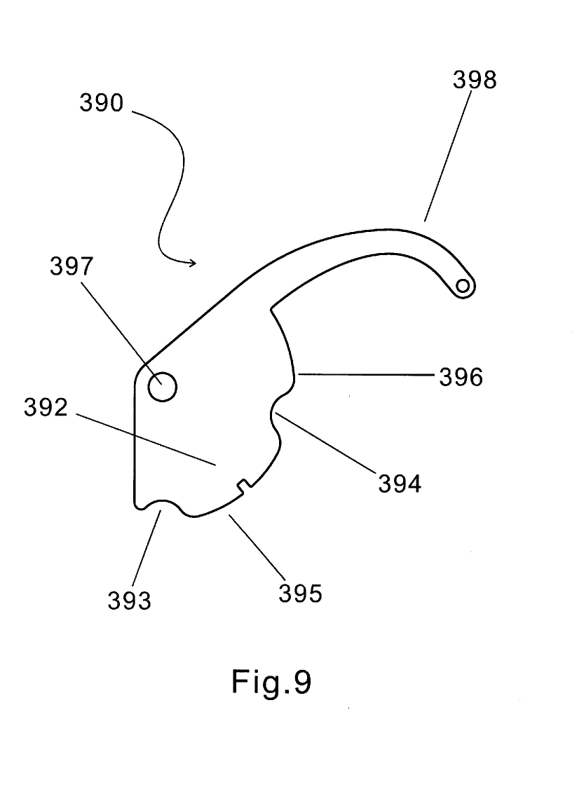

As shown in FIGS. 4, 8, 9 and 10, the pushing member 370 also includes a cavity 375 for receiving a push portion 392 of a lever 390. The push portion 392 is shielded in the cavity 375. The push portion 392 has a similar shape as the pushing member 370, having a first notch 393, a second notch 394 which match with the corresponding first groove 381 and second groove 382 of the pushing member 370, and a first flange 395 and a second flange 396 which match with the corresponding first lump 371 and second lump 372, so that the force from the lever 390 can be applied evenly on the pushing member 370.

The lever 390 has a lever portion 398 opposite to the push portion 392 for the user to apply force to operate the pushing member 370. A third pivot hole 397 is formed on the lever 390. In the embodiment, the lever portion 398 extends beyond an open slot 325 on the upper covering surface 322 of the housing 320, for connecting with a pulling handle 326. The lever portion 398 is movable along the open slot 325 when the pulling handle 326 is pulled by the user.

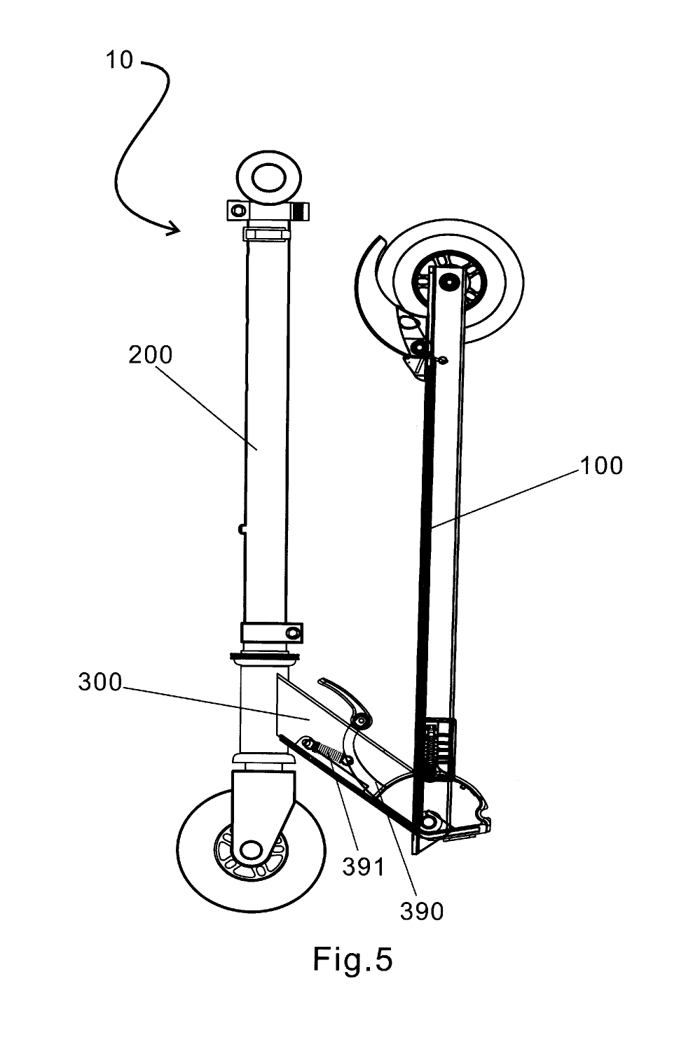

As shown in FIGS. 4 and 5, a second biasing device for example, a spring 391 connects the lever portion 398 to a lower plate 328 of the housing 320. The spring 391 returns the lever portion 398 to the original position in the housing 320 after being pulled by the user.

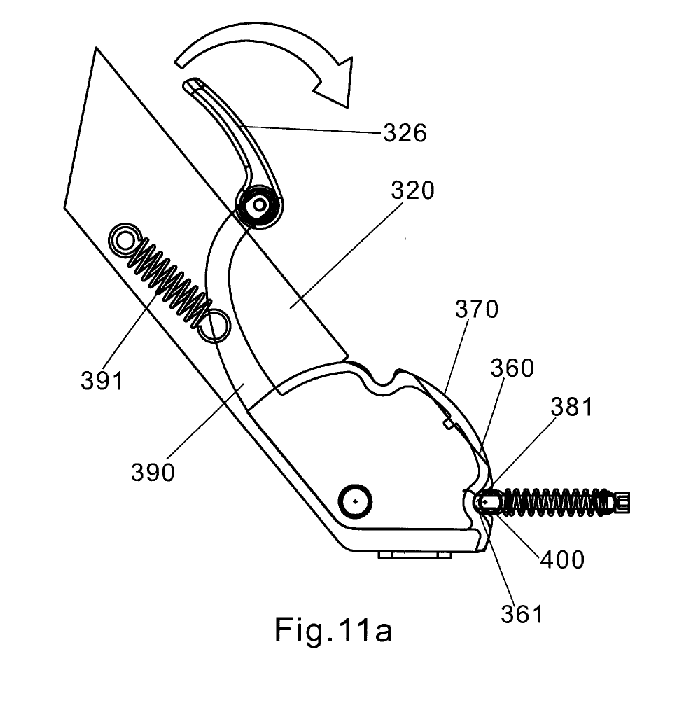

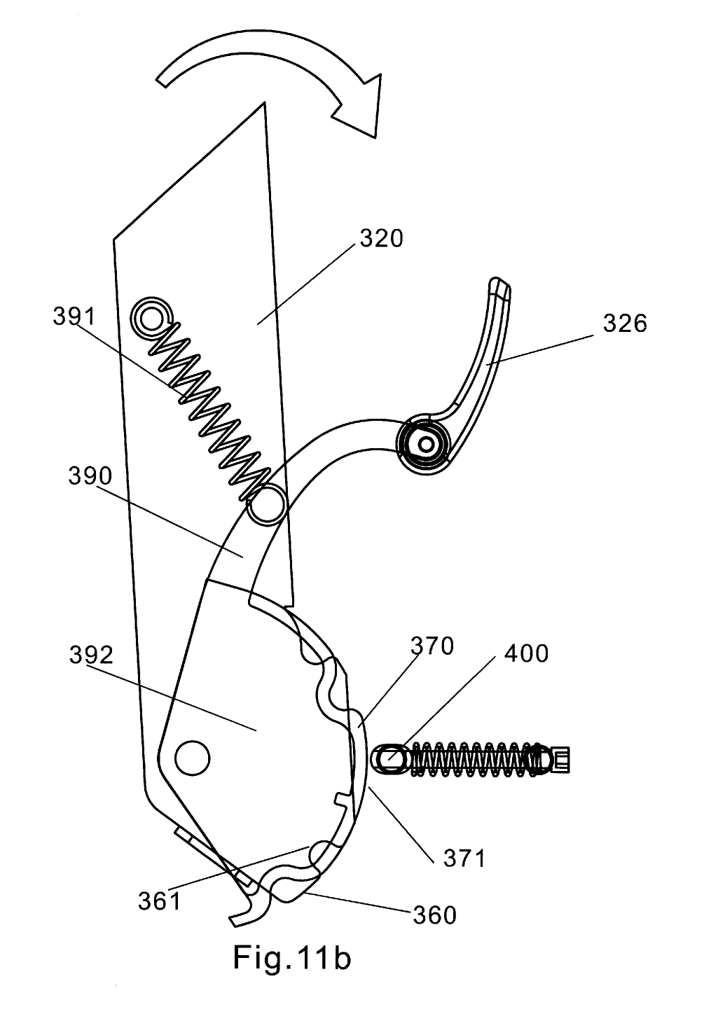

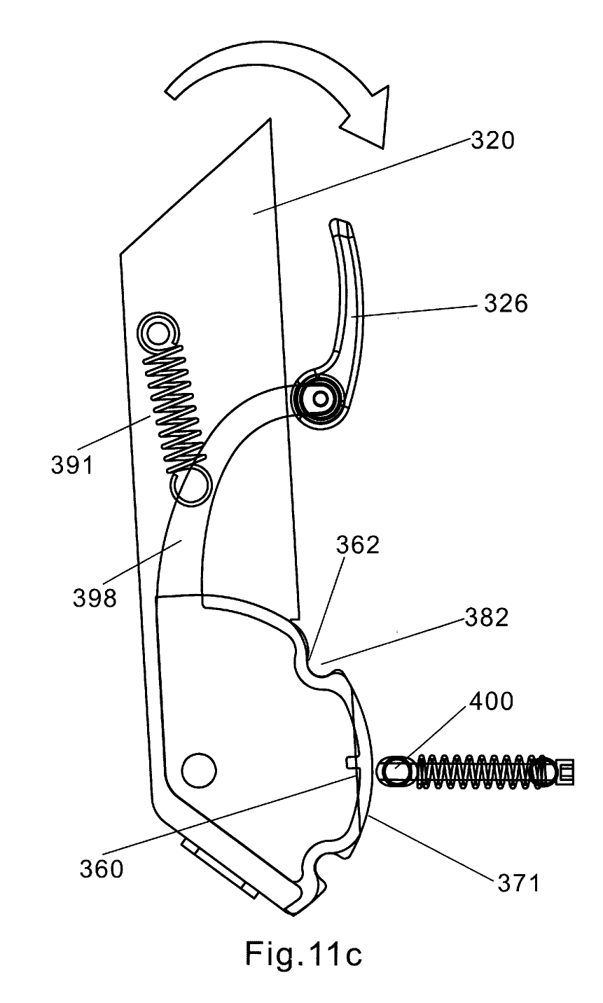

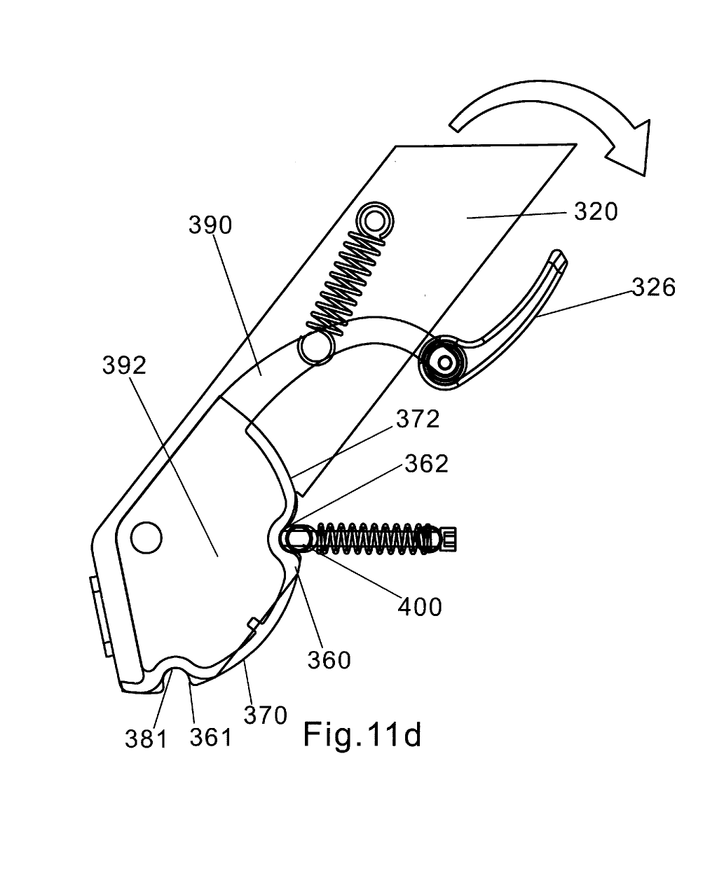

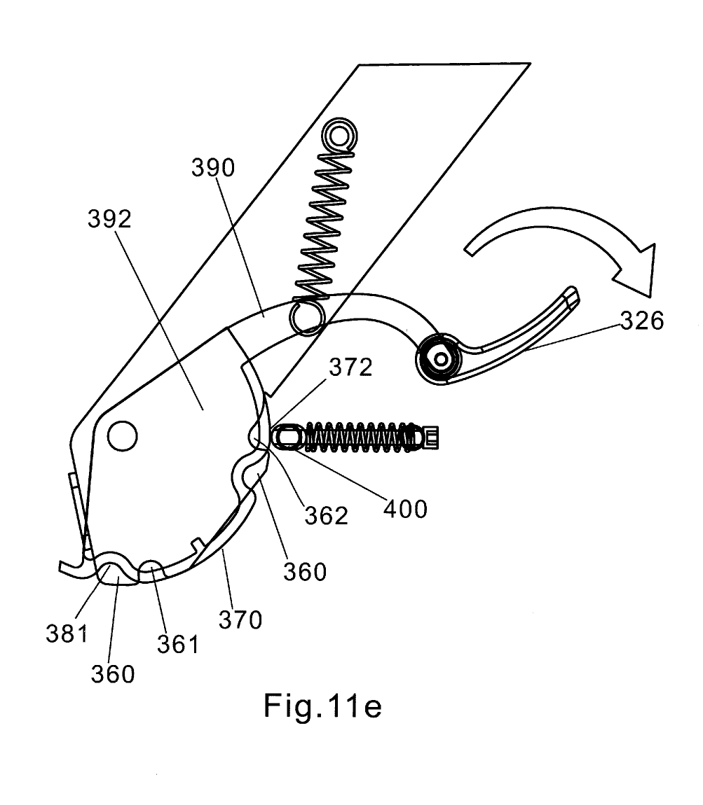

As shown in FIG. 11a, in the open condition of the scooter 10, the positioning member 400 is engaged in the first notch 361 of the mounting seats 360 and the first groove 381 of the pushing member 370, such that the positioning member 400 is locked on the mounting seats 360.

As shown in FIG. 11b, when the user pulls the pulling handle 326, the push portion 392 of the lever 390 causes the pushing member 370 to rotate pivotally and the first lump 371 to push the positioning member 400 away and disengage from the first notch 361 of the mounting seats 360.

As shown in FIG. 11c, the footboard 100 is folded toward the steering column 200 until the positioning member 400 is engaged with the second notch 362 and the second groove 382 in the folded condition and locked therein. The spring 391 is stretched when the pulling handle 326 is pulled, and is compressed to return the lever portion 398 to the original position in the housing 320 in the folded condition.

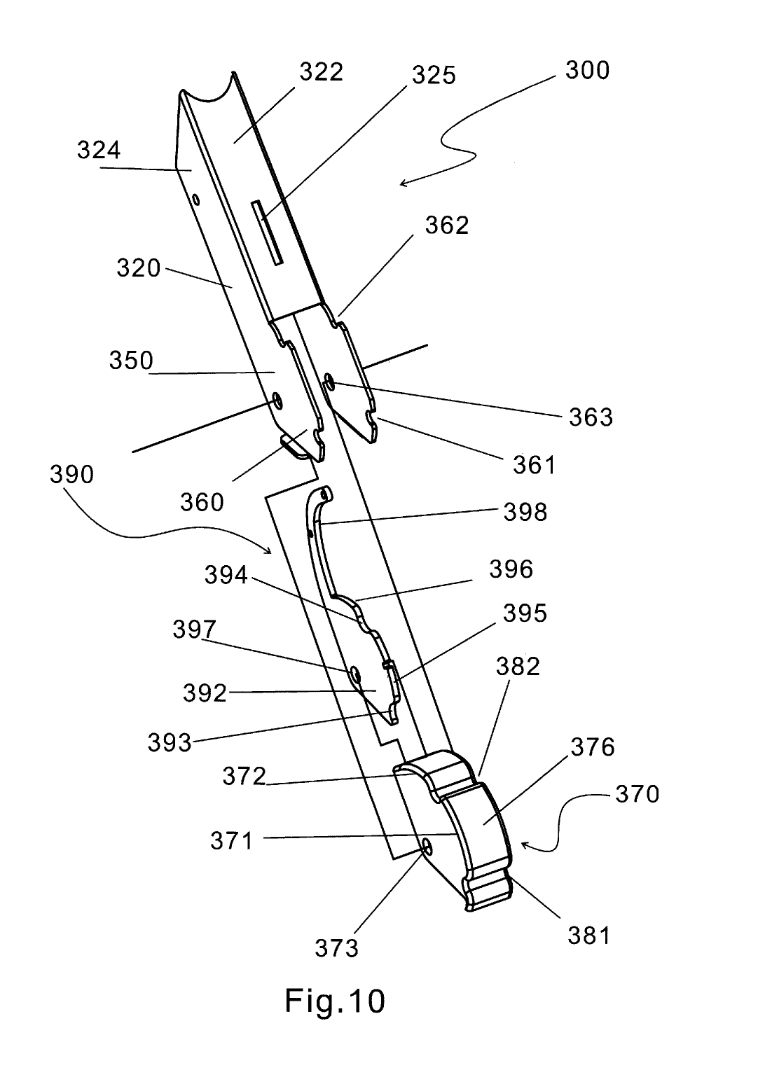

As shown in FIGS. 11d and 11e, to open the scooter 10 from the folded condition, the user pulls the pulling handle 326 to rotate the push portion 392 of the lever 390 pivotally and causes the second lump 372 of the pushing member 370 to push the positioning member 400 away and disengage from the second notch 362 of the mounting seats 360. The footboard 100 and the steering column 200 are unfolded until the positioning member 400 is engaged with the first notch 361 and the first groove 381 in the open condition and locked therein as shown in FIG. 10a. The spring 391 is stretched when the pulling handle 326 is pulled, and is compressed to return the lever portion 398 to the original position in the housing 320 in the open condition.

The lower plate 328 of the housing 320 shields the pushing member 370 and the push portion 392 of the lever 390 to prevent the user from accidentally inserting the finger from below the housing 320 when opening or unfolding the scooter 10.

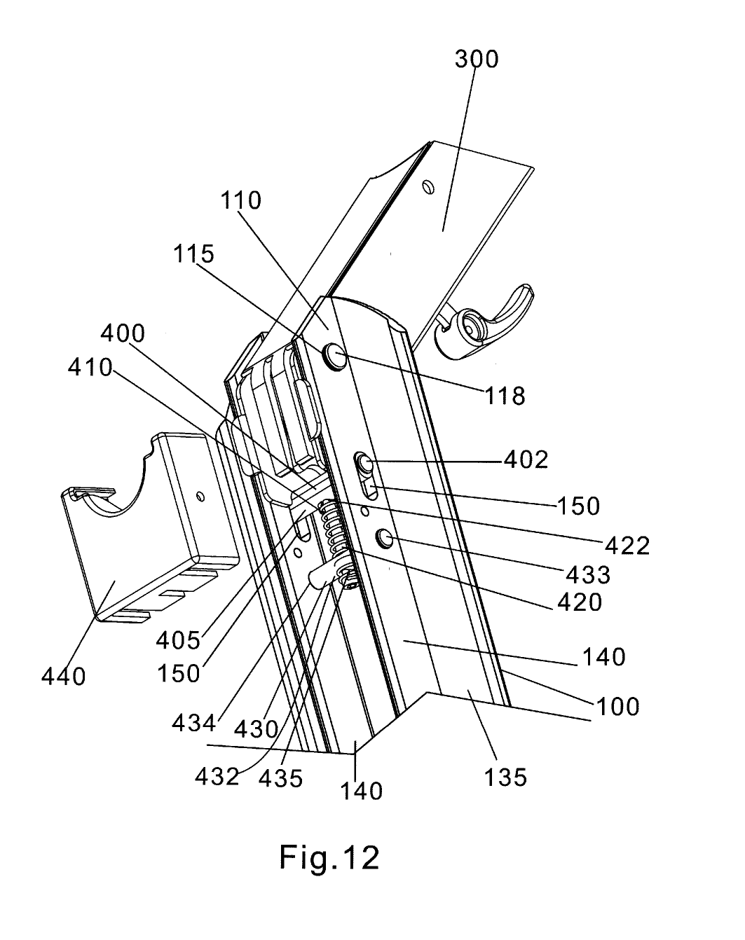

As shown in FIG. 12, two elongated supporting members 140 extend from a bottom surface 135 of the footboard 100 for supporting the footboard 100 against the weight of the user. At the front end 110, a fourth pivot hole 115 is formed on the supporting member 140. A pivotal pin 118 is disposed though the first, second, third and fourth pivot holes 363, 373, 397, 115 for joining the footboard 100, the connecting member 300, the pushing member 370 and the lever 390 together.

A slit 150 is disposed on each supporting member 140 for receiving the ends 402 of the positioning member 400 so that the positioning member 400 can be slidably moved along the slits 150 when operating between the open and folded conditions.

The body portion 405 of the positioning member 400, for example the middle portion, is attached to an end 422 of a first pin 420. The first pin 420 is slidably disposed through a hole 435 in a body portion 432, for example the middle portion, of a second pin 430, which has two ends 433, 434 each attached to the corresponding supporting member 140. A case 440 is attached to the supporting member 140 for shielding the positioning member 400, the first and second pins 420, 430 and the spring 410.

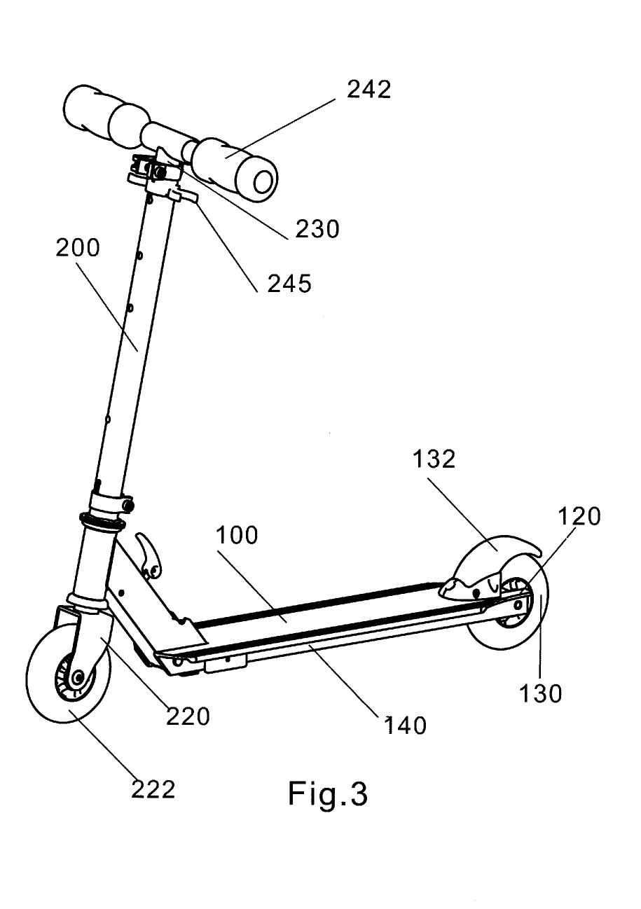

As shown in FIG. 3, a rear wheel 130 and a fender 132 for braking the rear wheel 130 are attached to the rear end 120 of the footboard 100. The steering column 200 may be telescopic for reducing the height when folding. A front wheel 222 is attached to the lower end 220 of the steering column 200. A steering handle 242 is attached to the upper end 230 of the steering column 200. The steering handle 242 may be detached and mounted on a clip 245 attached to the steering column 200 in the folded condition.

The embodiments described in this specification and the contents disclosed therein are provided by way of illustration only. The invention can be applied equally well on other types of foldable scooter.

While the invention has been described in detail with reference to disclosed embodiments, various modifications within the scope of the invention will be apparent to those of ordinary skill in this technological field. It is to be appreciated that features described with respect to one embodiment typically may be applied to other embodiments.

What is claimed is:

1. A foldable scooter operating between an open condition and a folded condition, comprising:
a footboard having a front end and a rear end attached to a rear wheel;
a steering column having a lower end attached to a front wheel and an upper end attached to a steering handle;
a connecting member having
an elongated housing with an upper covering surface, a front portion rotatably connected to said steering column and a rear portion pivotally connected to the front end of said footboard, said rear portion having two mounting seats each having a first notch and a second notch,
a pushing member pivotally disposed at said rear portion between said mounting seats,
a lever pivotally connected to said rear portion inside said housing for moving said pushing member, wherein said lever is shielded substantially by said housing under said upper covering surface;
a positioning member connected to a first biasing device disposed at the front end of said footboard for biasing said positioning member against said mounting seats, said positioning member is positioned at said first notch in the open condition and at said second notch in the folded condition,
whereby said pushing member disengages said positioning member from said first or second notch to operate between the open and folded conditions.

2. The foldable scooter as recited in claim 1, wherein said pushing member further comprises a first lump and a second lump, said first lump disengages said positioning member from said first notch to operate the scooter from the open condition to the folded condition, said second lump disengages said positioning member from said second notch to operate the scooter from the folded condition to the open condition.

3. The foldable scooter as recited in claim 1, wherein said pushing member further comprises a first groove and a second groove for engaging with said positioning member in the corresponding open and folded conditions.

4. The foldable scooter as recited in claim 2, wherein said pushing member further comprises a first groove and a second groove, said second groove is disposed between said first and second lump, said first groove is disposed adjacent to said first lump on the side opposite to said second groove.

5. The foldable scooter as recited in claim 1, wherein said push portion comprises a smooth and curved outer surface.

6. The foldable scooter as recited in claim 5, wherein each said mounting seat having an upper exposed portion, said outer surface disposed between said upper exposed portions is at the same level of or at slightly higher level than said upper exposed portions.

7. The foldable scooter as recited in claim 1, wherein said lever further comprises a push portion for driving said pushing member, said pushing member having a cavity for receiving said push portion, whereby said push portion is shielded inside said pushing member.

8. The foldable scooter as recited in claim 3, wherein said lever further comprises a push portion for driving said pushing member, said pushing member having a cavity for receiving said push portion, whereby said push portion is shielded inside said pushing member.

9. The foldable scooter as recited in claim 8, wherein said push portion further comprises a first notch and a second notch configured and positioned to match with said corresponding first groove and second groove.

10. The foldable scooter as recited in claim 2, wherein said push portion further comprises a first flange and a second flange configured and positioned to match with said corresponding first lump and second lump.

11. The foldable scooter as recited in claim 1, wherein said lever further comprises a lever portion for connecting with a pulling handle, an open slot disposed in said upper covering surface of said housing for said lever portion to move therein when operating between the open and closed conditions.

12. The foldable scooter as recited in claim 11, wherein a second biasing device is deposed in said housing and attached to said lever portion for biasing said lever portion to an original position after operating between the open and closed conditions.

13. The foldable scooter as recited in claim 12, wherein said second biasing device is a spring.

14. The foldable scooter as recited in claim 1, wherein said housing further comprises a lower plate for shielding said pushing member and the push portion of said lever.

15. The foldable scooter as recited in claim 1, wherein said first biasing device is a spring.

16. The foldable scooter as recited in claim 1, wherein said footboard further comprises a bottom surface and two elongated supporting members extending from said bottom surface, each supporting member having a slit at said front end, said positioning member comprises a positioning shaft having two ends each slidably disposed in said slit.

17. The foldable scooter as recited in claim 16, wherein said first biasing device is mounted on a first pin having a first end attached to said positioning shaft at a body portion thereof, said first pin is slidably disposed through a body portion of a second pin having two ends each attached to said corresponding supporting member.

18. The foldable scooter as recited in claim 16, wherein said housing further comprises a first pivot hole at said rear portion, said pushing member comprises a second pivot hole, said lever comprises a third pivot hole, each said supporting member comprises a fourth pivot hole at said front end, a pivotal pin is disposed in said first, second, third and fourth pivot holes.

19. The foldable scooter as recited in claim 1, wherein said footboard further comprises a case for shielding said positioning member and first biasing device.

20. The foldable scooter as recited in claim 17, wherein said footboard further comprises a case for shielding said positioning member, first biasing device, first and second pin.
